(19) United States
(12) Patent Application Publication
(10) Pub. No.: US 2016/0303934 A1
(43) Pub. Date: Oct. 20, 2016

(54) HITCH DRAWBAR STORAGE APPARATUS

(71) Applicant: Power Pin Inc., Fort Qu'Appelle (CA)

(72) Inventor: Brian R. Olson, Fort Qu'Appelle (CA)

(21) Appl. No.: 15/068,004

(22) Filed: Mar. 11, 2016

(30) Foreign Application Priority Data
Apr. 16, 2015 (CA) 2888339

(51) Int. Cl. B60D 1/58; B60P 7/08; B60D 1/52

(52) U.S. Cl. CPC B60D 1/58; B60D 1/52; B60P 7/08

(57) ABSTRACT

A hitch drawbar storage apparatus is adapted for installation in a variety of presently known pick-up truck boxes with a grooved floor where a top plate of each box extends inward from a top outside edge of the box and a rib extends downward from an inner edge of the top plate, and where a distance from the rib to a rib groove located under the rib varies. An adjustable length mounting leg is configured at a bottom end thereof to engage the rib groove such that right and left movement of the bottom end of the mounting leg is prevented, and a clamp device is operative to clamp an upper end of the mounting leg to the rib. Receiver tubes are mounted on the mounting leg, and each receiver tube is configured to receive a drawbar.

This invention is in the field of hitches for connecting a trailer or like towed vehicle to a towing vehicle, and in particular an apparatus for storing hitch tubes.

### BACKGROUND

Connecting hitch mechanisms for trailers take a variety of forms, such as clevis and tongue mechanisms, ball and socket mechanisms, pintle hook and ring mechanisms, and the like. In order to accommodate the different types of mechanisms it has become common to mount a tube bracket to the frame of the towing vehicle. A receiver tube is fixed to the tube bracket and defines a rectangular socket and allows an operator to insert and secure different rearward extending hitch drawbars that correspond to a variety of trailer hitches, thus facilitating towing a variety of trailers. The hitch drawbar can also be readily removed when not on use reducing the risk that a person will walk or drive into the drawbar.

Because these drawbars present somewhat of a hazard, in many jurisdictions it is illegal to leave the hitch drawbar in the socket on the towing vehicle, and so it is necessary to remove the drawbar and store it until the next time it is needed. Also it is common to have two different drawbars to accommodate two different trailers. Placing the drawbar loose in the truck box is inconvenient as they slide around the box and can interfere with loading the box. They can also be quite heavy and so present a hazard when the truck stops, starts, or turns suddenly sending the drawbar across the floor of the box.

U.S. Pat. No. 8,893,939 to Brass discloses a receiver tube mounted on a trailer where the drawbar is removed from the towing vehicle and stored with the trailer.

This kind of storage is suitable where the towing vehicle is used to pull only a single trailer.

U.S. Pat. No. 7,815,211 to Witchey, U.S. Pat. No. 6,527,292 to Adair, and U.S. Pat. No. 6,866,285 to Stamp disclose storage for a drawbar on the tube bracket, where the drawbar extends laterally in a storage position and rearward when in an operating position. U.S. Pat. No. 8,231,035 to Michael discloses a receiver tube mounted to the inside of a truck box to store a drawbar.

For storage on the towing vehicle of two drawbars U.S. Pat. No. 5,476,279 to Klemetsen discloses a laterally oriented receiver bracket which defines openings in each end thereof to store a drawbar extending laterally in each end. United States Published Patent Application Number 20080264991 of Foster discloses a pair of receiver tubes mounted in a tray that is bolted to holes drilled in the floor of a truck box.

Light trucks or pick-up trucks, such as the Ford™ F150, Chevrolet Silverado™, Dodge Ram™, and so forth, are commonly used for towing trailers. The boxes on these pick-up trucks are similar in that the steel floor of the boxes define grooves along their length from front to back, there is a rib extending down from the top inside edge of the box, and wheel wells extend up from the floor on each side of the box. The tray of Foster is bolted to the floor of such a pick-up truck near one side of the box just behind the wheel well where it is convenient to access the drawbars stored therein.

### SUMMARY OF THE INVENTION

The present disclosure provides a drawbar storage apparatus that overcomes problems in the prior art.

In a first embodiment the present disclosure provides a hitch drawbar storage apparatus for installation in a variety of pick-up truck boxes, where a top plate of each box extends inward from a top outside edge of the box and a rib extends downward from an inner edge of the top plate, where a floor of each box defines grooves extending from a front end of the box to a back end of the box, and where a distance from the rib to a rib groove located under the rib varies. The apparatus comprises an adjustable length mounting leg configured at a bottom end thereof to engage the rib groove such that right and left movement of the bottom end of the mounting leg is substantially prevented, and a clamp device operative to clamp an upper end of the mounting leg to the rib. Upper and lower receiver tubes are mounted on the mounting leg, and each receiver tube is configured to receive a drawbar.

The presently disclosed hitch drawbar storage apparatus can be quickly installed in the boxes presently found on a wide variety of brands of pick-up truck without drilling holes or otherwise altering the box itself, and provides convenient storage for at least two drawbars.

### DESCRIPTION OF THE DRAWINGS

While the invention is claimed in the concluding portions hereof, preferred embodiments are provided in the accompanying detailed description which may be best understood in conjunction with the accompanying diagrams where like parts in each of the several diagrams are labeled with like numbers, and where:

FIG. 1 is a schematic perspective view of an embodiment of the hitch drawbar storage apparatus of the present disclosure installed in a typical pick-up truck box;

FIG. 2 is a is a perspective front assembled view of the embodiment of FIG. 1 with a hitch drawbar installed in the lower receiver tube;

FIG. 3 is a perspective front exploded view of the embodiment of FIG. 1;

FIG. 4 is a is a perspective rear assembled view of the embodiment of FIG. 1;

FIG. 5 is a schematic rear view of the embodiment of FIG. 1 installed in a typical pick-up truck box.

### DETAILED DESCRIPTION OF THE ILLUSTRATED EMBODIMENTS

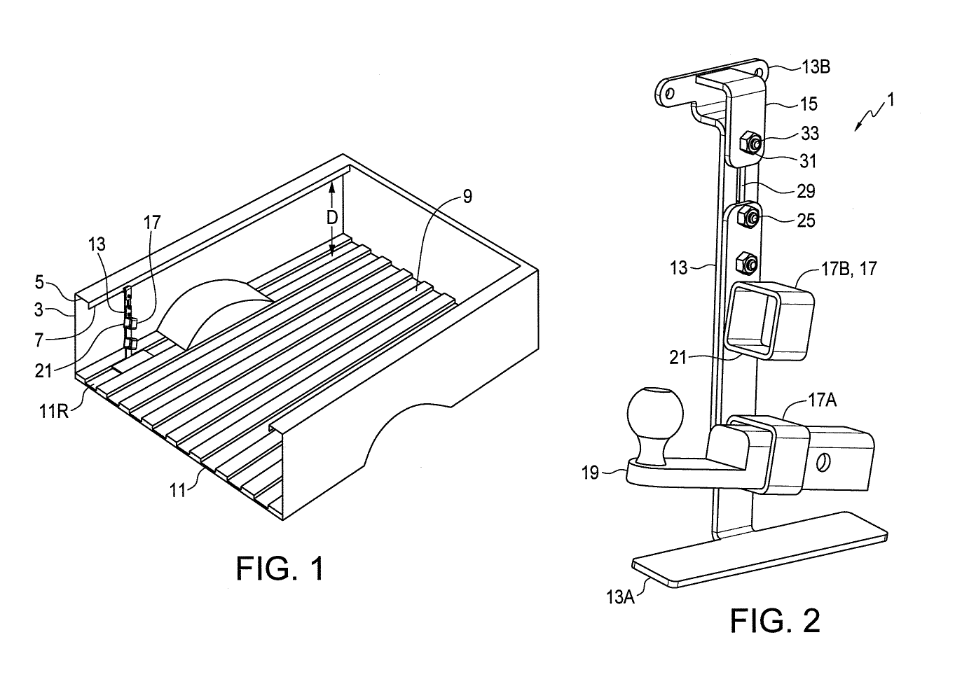

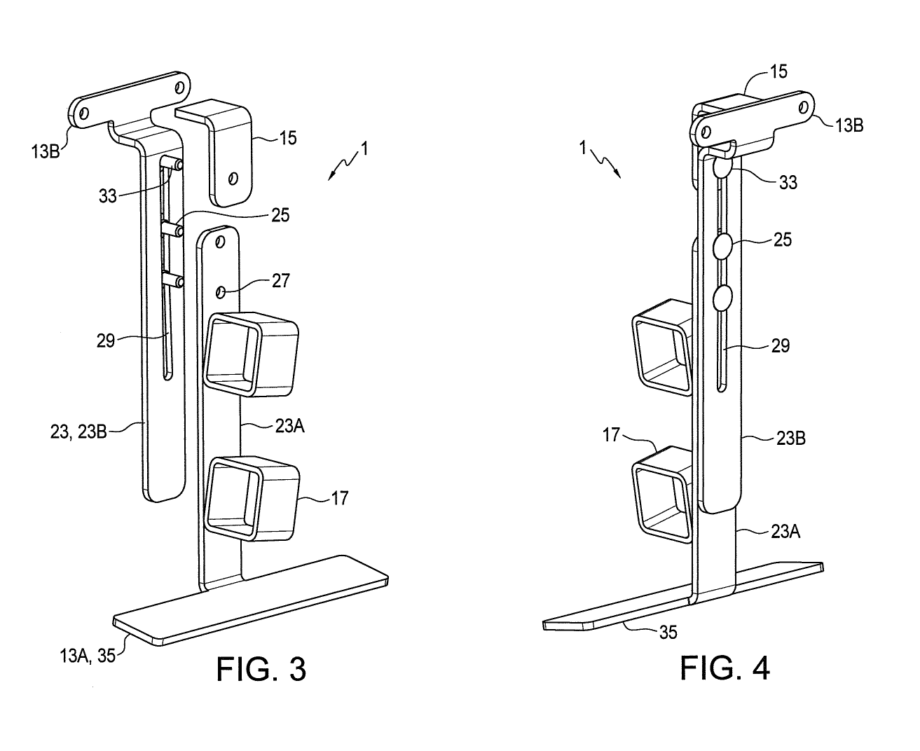

FIGS. 1-4 illustrate an embodiment of a hitch drawbar storage apparatus 1 of the present disclosure for installation in a variety of pick-up truck boxes. A large proportion of pick-up truck boxes have certain common features which the present apparatus 1 utilizes to allow installation of the apparatus 1. In a typical pick-up truck box 3 a top plate 5 of the box extends inward from a top outside edge of the box 3 and a rib 7 extends downward from an inner edge of the top plate 5. Similarly the floor 9 of a typical box 3 defines grooves 11 extending from a front end of the box 3 to a back end thereof. However in these typical pick-up truck boxes 3 the distance D from the rib 7 to a rib groove 11R located under the rib 7 varies from about 16 inches to 20 inches,

The apparatus 1 thus comprises an adjustable length mounting leg 13 configured at a bottom end 13A thereof to engage the rib groove 11A such that right and left movement of the bottom end 13A of the mounting leg 13 is substantially prevented, and a clamp device 15 is operative to clamp an upper end 13B of the mounting leg 13 to the rib 7. Lower and upper receiver tubes 17A, 17B are mounted on the mounting leg 13 and each receiver tube 17 is configured to receive a drawbar 19.

The upper and lower receiver tubes 17 slope downward from input ends 21 thereof where the drawbar 19 is inserted, to the opposite ends thereof, so that the drawbars 19 are held in place in the receiver tubes 17 by gravity. Pins may also be placed in the mounting holes thereof if desired as well. For convenience, the input ends 21 of the receiver tubes 17 face rearward when the mounting plate 13 is installed on the left driver's side of the box 3 as seen in FIG. 1.

The illustrated mounting leg 13 comprises a lower leg 23A and an upper leg 23B, and the upper and lower legs 23 are fixed to each other at a selected relative vertical position by bolts 25 extending through bolt holes 27 defined by the lower leg 23A and then through a vertical slot 29 defined by the upper leg 23B. The receiver tubes 17 are mounted on the lower legs under the bolt holes 27. Conveniently the bolts 25 are carriage bolts with a square head that engages the sides of the slot 29 to facilitate tightening nuts 31 onto the bolts 25.

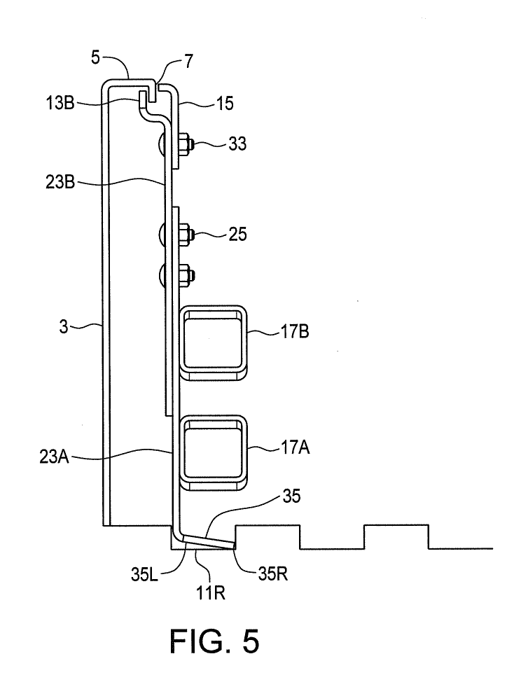

The clamp device 15 is fastened to the upper leg 23B by a clamp bolt 33 extending through an upper portion of the vertical slot 29. As schematically illustrated in FIG. 5, the upper end of 13B of the mounting leg 13 on upper leg 23B extends upward on a rear side of the rib 7 and the clamping device 15 bears against the front side of the rib 7 opposite the upper end 13B of the mounting leg 13. It is contemplated that the upper end of 13B of the mounting leg 13 could also extends upward on the front side of the rib 7 and the clamping device 15 bear against the rear side of the rib 7.

The bottom end 13A of the mounting leg 13 comprises a base plate 35 configured to slide down into the rib groove 11R with right and left side edges of the base plate 13 in sliding relationship to corresponding right and left sides of the rib groove 11R. The base plate 35 slopes laterally such that the right side edge 35R thereof is lower than the left side edge 35L and bears against a bottom corner of the rib groove 11R. It is contemplated that this configuration will better resist lateral movement of the bottom end 13A of the mounting leg 13.

The presently disclosed hitch drawbar storage apparatus 1 can be readily installed in the boxes presently found on a wide variety of brands of pick-up truck without drilling holes or otherwise altering the box itself, and provides convenient storage for at least two drawbars 19.

The foregoing is considered as illustrative only of the principles of the invention. Further, since numerous changes and modifications will readily occur to those skilled in the art, it is not desired to limit the invention to the exact construction and operation shown and described, and accordingly, all such suitable changes or modifications in structure or operation which may be resorted to are intended to fall within the scope of the claimed invention.

What is claimed is:

1. A hitch drawbar storage apparatus for installation in a variety of pick-up truck boxes, where a top plate of each box extends inward from a top outside edge of the box and a rib extends downward from an inner edge of the top plate, where a floor of each box defines grooves extending from a front end of the box to a back end of the box, and where a distance from the rib to a rib groove located under the rib varies, the apparatus comprising:
an adjustable length mounting leg configured at a bottom end thereof to engage the rib groove such that right and left movement of the bottom end of the mounting leg is substantially prevented;
a clamp device operative to clamp an upper end of the mounting leg to the rib;
upper and lower receiver tubes mounted on the mounting leg, each receiver tube configured to receive a drawbar.

2. The apparatus of claim 1 wherein the upper and lower receiver tubes slope downward from input ends thereof where the drawbar is inserted, to opposite ends thereof.

3. The apparatus of claim 2 wherein the input ends of the receiver tubes face rearward when the mounting plate is installed on a left side of the box.

4. The apparatus of claim 1 wherein the mounting leg comprises an upper leg and a lower leg, and wherein the upper and lower legs are fixed to each other at a selected relative vertical position by a bolt extending through a bolt hole defined by one of the upper and lower legs and then through a vertical slot defined by the other of the upper and lower legs.

5. The apparatus of claim 4 the upper and lower receiver tubes are mounted on the one of the upper and lower legs that defines the bolt hole.

6. The apparatus of claim 4 wherein the upper leg defines the vertical slot, the upper and lower receiver tubes are mounted on the lower leg, and the lower leg defines the bolt hole above the upper receiver tube.

7. The apparatus of claim 6 wherein the clamp device is fastened to the upper leg by a clamp bolt extending through an upper portion of the vertical slot.

8. The apparatus of claim 7 wherein the upper end of the mounting leg is configured to extend upward on one side of the rib and wherein the clamping device bears against a side of the rib opposite the upper end of the mounting leg.

9. The apparatus of claim 1 wherein the bottom end of the mounting leg comprises a base plate configured to slide down into the rib groove with right and left side edges of the base plate in sliding relationship to corresponding right and left sides of the rib groove.

10. The apparatus of claim 9 wherein the base plate slopes laterally such that one of the right and left side edges thereof is lower than the other and bears against a bottom corner of the rib groove.
